(19) United States
(12) Patent Application Publication
(10) Pub. No.: US 2023/0071688 A1
(43) Pub. Date: Mar. 9, 2023

(54) SYSTEM AND METHOD OF CONTROLLING NEURAL PROCESSING

(71) Applicant: SAMSUNG ELECTRONICS CO., LTD., SUWON-SI (KR)

(72) Inventors: HYUKJOON LEE, SEOUL (KR); SANGSOO KO, YONGIN-SI (KR); HANYOUNG YIM, SUWON-SI (KR); WOOHYUN JOO, SUWON-SI (KR); MINSEONG KIM, SEONGNAM-SI (KR); SANGHYUCK HA, YONGIN-SI (KR)

(21) Appl. No.: 17/706,062

(22) Filed: Mar. 28, 2022

(30) Foreign Application Priority Data
Sep. 7, 2021 (KR) 10-2021-0118850

(51) Int. Cl. G06N 3/08; G06N 3/04

(52) U.S. Cl. CPC G06N 3/08; G06N 3/04

(57) ABSTRACT

A system of controlling neural processing based on deep reinforcement learning includes an agent circuit and an environment circuit. The agent circuit generates a plurality of agents based on layers included in a neural network model. Each agent repeatedly performs an iteration to determine a next action among a plurality of candidate actions based on a reward value and a plurality of Q values corresponding to a present action, where the candidate actions indicate a change of a tiling condition of an input feature map of each layer. Each agent determines an optimal tiling condition of each layer based on change of the reward value according to repeatedly-performed iterations. The environment circuit generates the reward value and the plurality of Q values with respect to each layer based on a tiling condition corresponding to the present action, where the Q values indicate prediction reward values of the candidate actions.

### CROSS-REFERENCE TO RELATED APPLICATION

This U.S. non-provisional patent application claims priority under 35 USC § 119 to Korean Patent Application No. 10-2021-0118850, filed on Sep. 7, 2021 in the Korean Intellectual Property Office (KIPO), the disclosure of which is incorporated by reference herein in its entirety.

### BACKGROUND

### 1. Technical Field

Example embodiments relate generally to semiconductor integrated circuits, and more particularly to systems and methods of controlling neural processing based on deep reinforcement learning.

### 2. Discussion of the Related Art

As the number and types of fields to which artificial intelligence (AI) is applied increase, a neural processing device such as a neural processing unit (NPU) has to support an increasing number and an increasing type of neural network models. A tiling condition of dividing input data of the neural network models for efficient processing is determined through experiments based on heuristic schemes. The heuristic schemes take much time to determine an optimal tiling condition. In addition, the heuristic schemes may not exactly reflect random factors such as binary size of the processed data, performance degradation of the neural processing device due to operation temperature, and so on. Further, the tiling condition has to be optimized again according to changes of hardware and/or software characteristics of the neural processing device and changes of a neural network model.

### SUMMARY

Some example embodiments may provide systems and methods of controlling neural processing based on deep reinforcement learning, capable of efficiently optimizing a tiling condition of a neural network model.

According to example embodiments, a system of controlling neural processing based on deep reinforcement learning includes an agent circuit and an environment circuit. The agent circuit generates a plurality of agents based on a plurality of layers included in a neural network model. Each agent repeatedly performs an iteration to determine a next action among a plurality of candidate actions based on a reward value and a plurality of Q values corresponding to a present action among the plurality of candidate actions, where the plurality of candidate actions indicate a change of a tiling condition of an input feature map of each layer. Each agent determines an optimal tiling condition of each layer based on change of the reward value according to repeatedly-performed iterations. The environment circuit generates the reward value and the plurality of Q values with respect to each layer based on a tiling condition corresponding to the present action, where the plurality of Q values indicate prediction reward values of the plurality of candidate actions.

According to example embodiments, a system of controlling neural processing based on deep reinforcement learning includes an agent circuit, a simulation environment circuit and a device environment circuit. The agent circuit generates a plurality of agents based on a plurality of layers included in a neural network model. Each agent repeatedly performs an iteration to determine a next action among a plurality of candidate actions based on a reward value and a plurality of Q values corresponding to a present action among the plurality of candidate actions, where the plurality of candidate actions indicate a change of a tiling condition of an input feature map of each layer. Each agent determines an optimal tiling condition of each layer based on change of the reward value according to repeatedly-performed iterations. The simulation environment circuit performs simulation to calculate a simulation processing time of the neural network model, and trains a prediction network based on the simulation processing time such that the prediction network receives the tiling condition and outputs the plurality of Q values. The device environment circuit measures a real processing time of a neural processing device driving the neural network model based on the tiling condition corresponding to the present action and trains a compensation network based on the real processing time such that the compensation network receives the tiling condition and outputs a plurality of compensation Q values corresponding to the plurality of Q values. A structure of the prediction network is identical to a structure of the compensation network, and the simulation environment circuit corrects weight values of the prediction network based on weight values of the compensation network.

According to example embodiments, a method of controlling neural processing based on deep reinforcement learning includes generating a plurality of agents based on a plurality of layers included in a neural network model; repeatedly performing, by each agent, an iteration to determine a next action among a plurality of candidate actions based on a reward value and a plurality of Q values corresponding to a present action among the plurality of candidate actions, the plurality of candidate actions indicating a change of a tiling condition of an input feature map of each layer; generating the reward value and the plurality of Q values with respect to each layer based on a tiling condition corresponding to the present action, the plurality of Q values indicating prediction reward values of the plurality of candidate actions, and determining, by each agent, an optimal tiling condition of each layer based on change of the reward value according to repeatedly performed iterations.

### BRIEF DESCRIPTION OF THE DRAWINGS

Example embodiments of the present disclosure will be more clearly understood from the following detailed description taken in conjunction with the accompanying drawings.

FIG. 1 is a flowchart illustrating a method of controlling neural processing based on deep reinforcement learning according to example embodiments.

FIG. 2 is a block diagram illustrating a system of controlling neural processing based on deep reinforcement learning according to example embodiments.

FIG. 3 is a flowchart illustrating a method of configuring a system of controlling neural processing based on deep reinforcement learning according to example embodiments.

FIG. 4 is a flowchart illustrating an operation of a system of controlling neural processing based on deep reinforcement learning according to example embodiments.

FIG. 5 is a block diagram illustrating a computing system according to example embodiments.

FIG. 6, FIG. 7 and FIG. 8 are diagrams for describing examples of a neural network structure that is driven by a computing device according to example embodiments.

FIG. 9 is a diagram illustrating an example of a node included in a neural network.

FIG. 10 is a diagram for describing a tiling condition in a system of controlling neural processing according to example embodiments.

FIG. 11 is a diagram illustrating an example embodiment of candidate actions in a system of controlling neural processing according to example embodiments.

FIG. 12 is a block diagram illustrating an example embodiment of an environment module included in a system of controlling neural processing according to example embodiments.

FIG. 13 is a flowchart illustrating an example embodiment of generating Q values in a system of controlling neural processing according to example embodiments.

FIG. 14 is a block diagram illustrating an example embodiment of a simulation environment unit included in a system of controlling neural processing according to example embodiments.

FIG. 15 is a block diagram illustrating an example embodiment of a device environment unit included in a system of controlling neural processing according to example embodiments.

FIG. 16 is a diagram illustrating a prediction network that is trained by the simulation environment unit of FIG. 14 and a compensation network that is trained by the device environment unit of FIG. 15.

FIG. 17 is a block diagram illustrating a computing system according to example embodiments.

FIG. 18 is a diagram illustrating an example embodiment of a system of controlling neural processing implemented in the computing system of FIG. 17.

### DETAILED DESCRIPTION OF THE EMBODIMENTS

Various example embodiments will be described more fully hereinafter with reference to the accompanying drawings, in which some example embodiments are shown. In the drawings, like numerals refer to like elements throughout. The repeated descriptions may be omitted.

Reinforcement learning indicates a method of training a neural network based on rewards obtained by performing actions under unknown environments. For example, artificial intelligence (AI) may enhance its performance through deep reinforcement learning. Deep reinforcement learning indicates a technology such that deep learning is applied to the reinforcement learning. Deep reinforcement learning is a form of Q-value approximation to which a deep neural network is applied. Whereas a p-value is an area under the tail of a distribution that indicates the likelihood of a result happening by chance, a Q-value is a form of p-value which is adjusted for the false discovery rate (the proportion of false positives to be expected from a test). The Q value indicates a reward that is predicted when an action is performed under a specific state. The deep neural network applied to the Q-value approximation is referred to as a deep Q network (DQN).

The deep reinforcement learning may be implemented by interaction of agent and environment. The agent may select an action corresponding to the highest reward that is predicted and the state is changed by the action. The environment may provide, as the Q value, the reward that is predicted for each action in the changed state.

Example embodiments apply the deep reinforcement learning to optimize a condition of neural processing, for example, a tiling condition of an input feature map of a layer included in a neural network model. In this disclosure, the tiling condition corresponds to the state of the deep reinforcement learning and the change of the tiling condition corresponds to the action of the deep reinforcement learning.

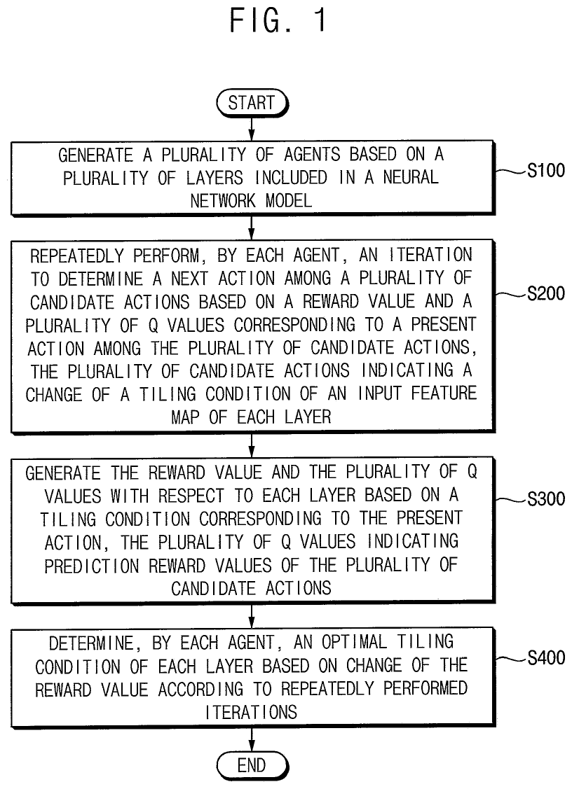

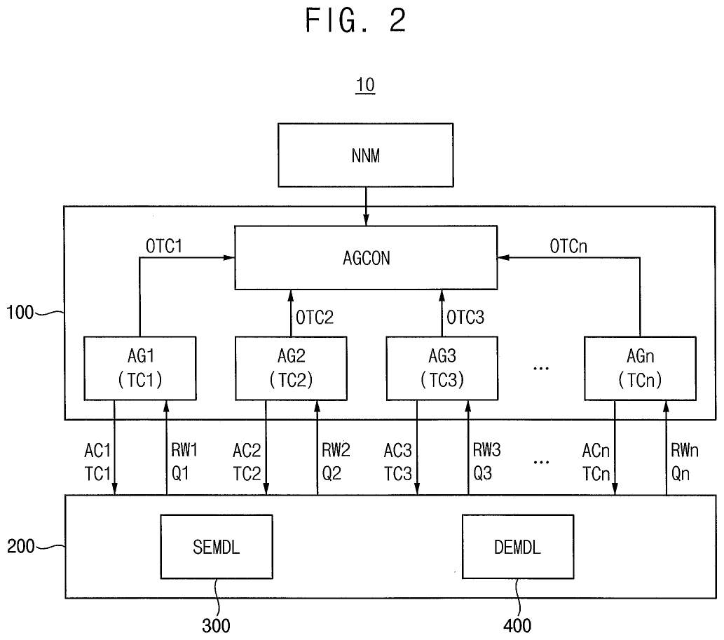

FIG. 1 is a flowchart illustrating a method of controlling neural processing based on deep reinforcement learning according to example embodiments, and FIG. 2 is a block diagram illustrating a system of controlling neural processing based on deep reinforcement learning according to example embodiments.

Before proceeding, it should be clear that Figures herein, including FIG. 2 as described below, show and reference circuitry with labels such as “module”, “controller” and “unit” or similar terms analogous to “circuit” or “block”. As is traditional in the field of the inventive concept(s) described herein, examples may be described and illustrated in terms of such labelled elements which carry out a described function or functions. These labelled elements, or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting such labelled elements may be implemented by dedicated hardware, or by a processor (e.g., one or more programmed microprocessors and associated circuitry), or by a combination of dedicated hardware to perform some functions of the labelled element and a processor to perform other functions of the labelled element. Each labelled element of the examples may be physically separated into two or more interacting and discrete circuits without departing from the scope of the present disclosure.

Referring to FIG. 2, a neural processing control system 10 may include an agent module 100 and an environment module 200. The agent module 100 may be or include a discrete circuit of one or more circuit elements, and thus may be an agent circuit. The environment module 200 may also be or include a discrete circuit or one or more circuit elements, and thus may be an environment circuit. The agent module 100 may include an agent controller AGCON and a plurality of agents AG1˜AGn. The environment module 200 may include a simulation environment module 300 (SEMDL) and a device environment module 400 (DEMDL). The simulation environment module 300 may be or include a discrete circuit of one or more circuit elements, and thus may be an simulation environment circuit. The device environment module 400 may be or include a discrete circuit of one or more circuit elements, and thus may be a device environment circuit. In some example embodiments, the environment module 200 may include only the simulation environment module 300 and the device environment module 400 may be omitted.

Referring to FIG. 1 and FIG. 2, the agent controller AGCON may generate a plurality of agents AG1˜AGn based on a plurality of layers included in a neural network model NNM (S100). In some example embodiments, the neural network model NNM may include first through n-th layers and the agent controller AGCON may generate first through n-th agents AG1˜AGn respectively corresponding to the first through n-th layers. In some example embodiments, the agent controller AGCON may generate the agents for a portion of the layers included in the neural network model NNM and in this case the number of the generated agents may be smaller than the number of layers.

The neural network model NNM of the neural processing control system 10 may be changed, and the agent controller AGCON may change the number of the plurality of agents AG1˜AGn according to the number of layers included in the changed neural network model NNM. As such, the agent controller AGCON may generate the agents adaptively depending on the neural network model NNM and example embodiments may be applied regardless of the kind of the neural network model NNM.

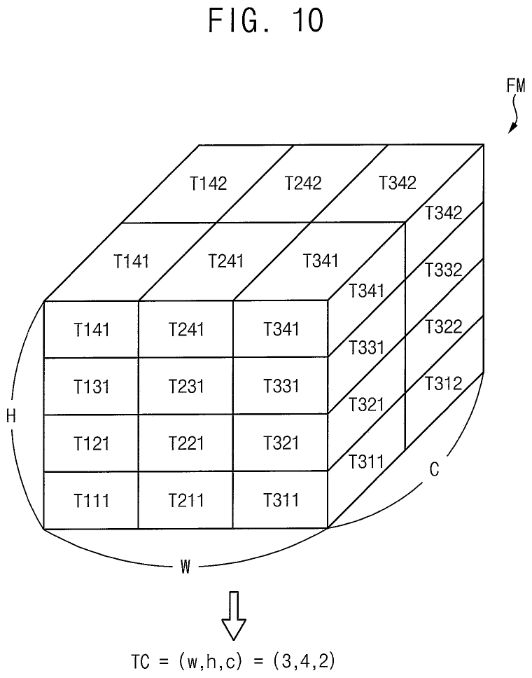

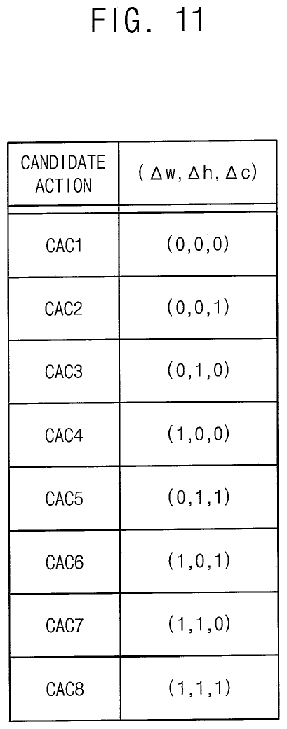

Each agent AGi (i=1˜n) among the plurality of agents AG1˜AGn may repeatedly perform an iteration to determine a next action among a plurality of candidate actions based on a reward value RWi and a plurality of Q values Qi corresponding to a present action ACi among the plurality of candidate actions where the plurality of candidate actions indicate a change of a tiling condition TCi of an input feature map of each layer (S200). An example embodiment of the tiling condition TCi will be described below with reference to FIG. 10, and an example embodiment of the plurality of candidate actions will be described below with reference to FIG. 11.

The environment module 200 may generate the reward value RWi and the plurality of Q values Qi with respect to each layer based on the tiling condition TCi corresponding to the present action where the plurality of Q values Qi indicate prediction reward values of the plurality of candidate actions (S300).

In some example embodiments, the environment module 200 may include the simulation environment module 300. The simulation environment module 300 may generate the reward value RWi and the plurality of Q values Qi based on a result of simulation. In some example embodiments, the environment module 200 may further include the device environment module 400 in addition to the simulation environment module 300. The device environment module 400 may be used to correct the simulation environment module 300 based on measurement of real processing time.

Each agent AGi may determine an optimal tiling condition OTCi of each layer based on change of the reward value RWi according to repeatedly-performed iterations (S400). Each agent AGi may repeat the iteration to determine the optimal tiling condition OTCi of each layer regardless of the other agents.

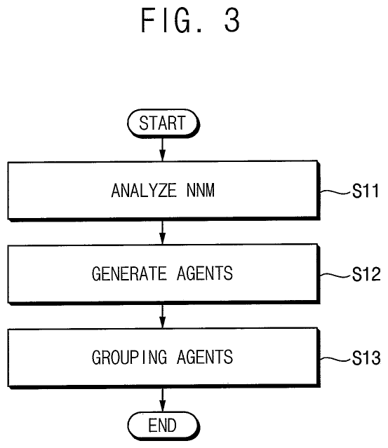

FIG. 3 is a flowchart illustrating a method of configuring a system of controlling neural processing based on deep reinforcement learning according to example embodiments.

Referring to FIG. 2 and FIG. 3, the agent controller AGCON may analyze a structure of the neural network model NNM (S11), and generate the plurality of agents AG1˜AGn based on the analyzed structure of the neural network model NNM (S12).

In some example embodiments, the agent controller AGCON may group the plurality of agents AG1˜AGn based on attributes of the layers included in the neural network model NNM.

The agent controller AGCON of the agent module 100 may group into each agent group agents corresponding to layers of the same kind, corresponding to the same size of the input feature map and/or corresponding to the same size of output feature map. In this case, the agents in each agent group may share the reward value and the plurality of Q values.

As such, the training time of the environment module 200 may be reduced by grouping the agents of the same attributes and sharing the reward between the agents in the same agent group to omit generation of redundant actions and states.

The agents in the same agent group may share the optimal tiling condition because the agents in the same agent group correspond to the layers of the same attributes.

In some example embodiments, when one agent in each agent group determines the optimal tiling condition first, the other agents in each agent group stop operations. In this case, the agent controller AGCON may determine the optimal tiling condition determined by the one agent as optimal tiling conditions of layers corresponding to the other agents.

In some example embodiments, the agent controller AGCON may enable one agent in each agent group and disable the other agents in each agent group. In this case, the agent controller AGCON may determine the optimal tiling condition determined by the one enabled agent as the optimal tiling conditions of layers corresponding to the other disabled agents.

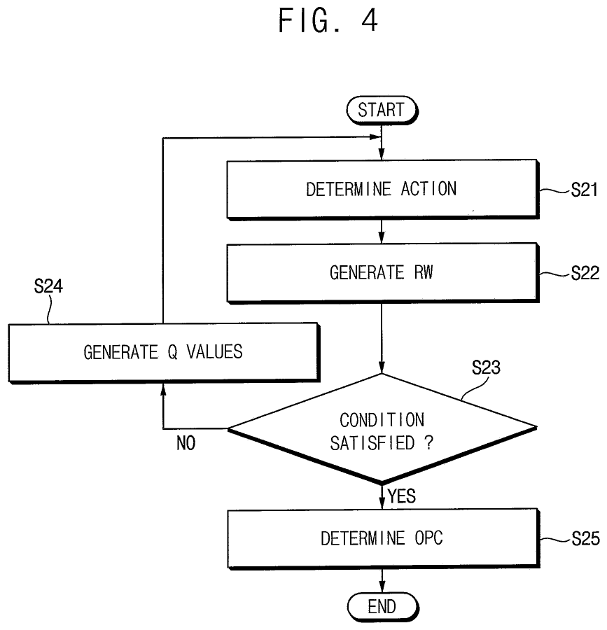

FIG. 4 is a flowchart illustrating an operation of a system of controlling neural processing based on deep reinforcement learning according to example embodiments.

FIG. 4 illustrates an operation corresponding to each agent. The operation as illustrated in FIG. 4 may be performed with respect to each of the plurality of agents AG1˜AGn that are generated by the agent controller AGCON.

Each agent in the agent module 100 may determine the present action based on the reward value and the plurality of Q values corresponding to the previous action (S21). The environment module 200 may generate the reward value RW based on the tiling condition corresponding to the present action, that is, the tiling condition that is changed by the present action (S22).

Each agent may determine whether a condition for determining the optimal tiling condition OPC is satisfied (S23). For example, each agent may determine whether the condition is satisfied based on Expression 1.

RWt−RWt−1<ε Expression 1

In Expression 1, RWt indicates the reward value corresponding to the present action of the t-th iteration, RWt−1 indicates the reward value corresponding to the previous action of the (t−1)-th iteration, and ε indicates a reference value. Each agent may determine that the condition for the optimal tiling condition OPC is satisfied when the condition of Expression 1 is satisfied for a predetermined number of iterations.

When the condition for the optimal tiling condition OPC is satisfied (S23: YES), each agent may determine the present tiling condition as the optimal tiling condition OPC (S25) and stop its operation.

When the condition for the optimal tiling condition OPC is not satisfied (S23: NO), the environment module 200 may generate the plurality of Q values corresponding to the tiling condition that is changed by the present action (S24).

As such, the iteration may be repeated to determine the next action based on the reward value RW and the plurality of Q values provided from the environment module 200 until the condition for the optimal tiling condition OPC is satisfied.

The reinforcement learning may be implemented as algorithm software, a corresponding hardware or a combination of software and hardware, comprised of an environment, an agent, a state, an action and a reward. First the agent may take an action to move into a new state. The agent may receive two rewards for the action, that is, an immediate reward and a future reward, from the environment. The immediate reward indicates an instant reward for the taken action and the future reward indicates a reward for a future environment by the action. The above-described reward value RW may correspond to the immediate reward and the above-described Q values may correspond to the future reward.

As shown in Expression 2, the ultimate object of the agent is to update the Q values such that the two rewards may be maximized.

Qₜ₊₁(sₜ,αₜ)←Qₜ(sₜ,αₜ)+αₜ(sₜ,αₜ)*[rₜ₊₁+γ max_{α}Qₜ(sₜ₊₁,α)−Q(sₜ,αₜ) Expression 2

In Expression 2, ‘s’ indicates the state, ‘a’ indicates the action, ‘r’ indicates the reward. ‘γ’ is a discount factor having a value between 0 and 1, and the future reward may be emphasized as the discount factor approached the value of 1. In some example embodiments, the discount factor may be set to the value of 0.5 to consider evenly the present and future rewards. ‘αₜ’ is a learning rate having a value between 0 and 1 to determine a leaning speed of the Q value. For example, the agent may not perform the learning when αₜ=0, and the agent may perform the learning using the most recent information when αₜ=1.

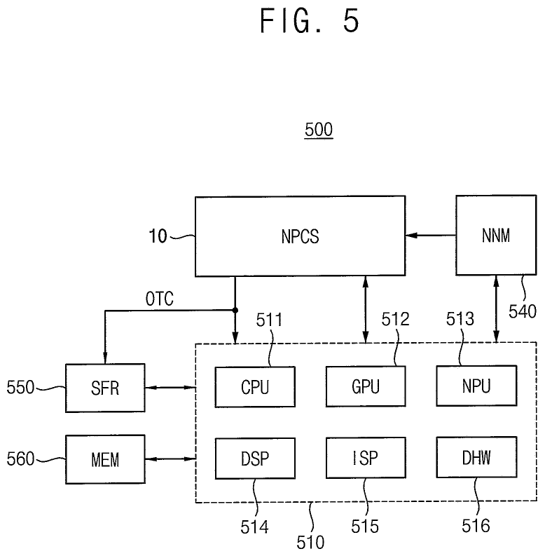

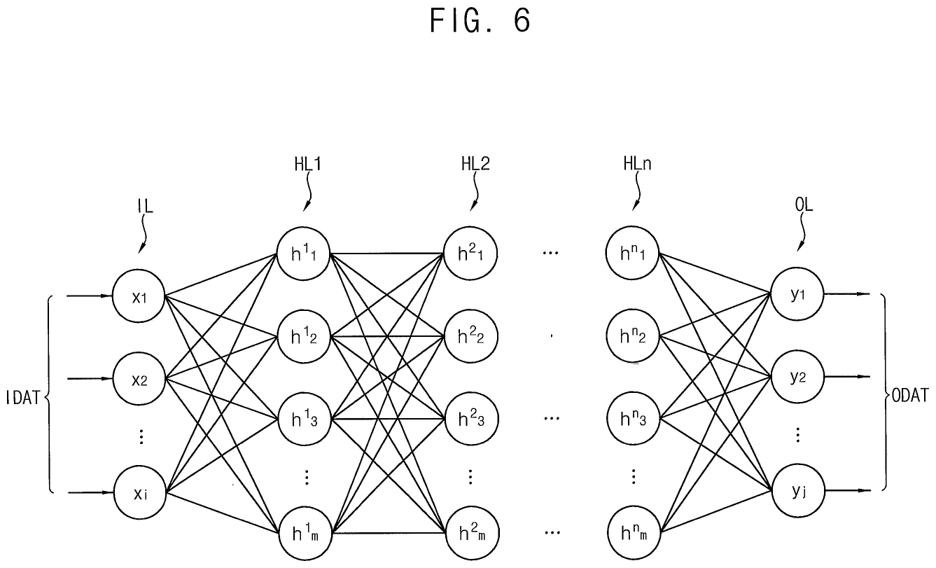

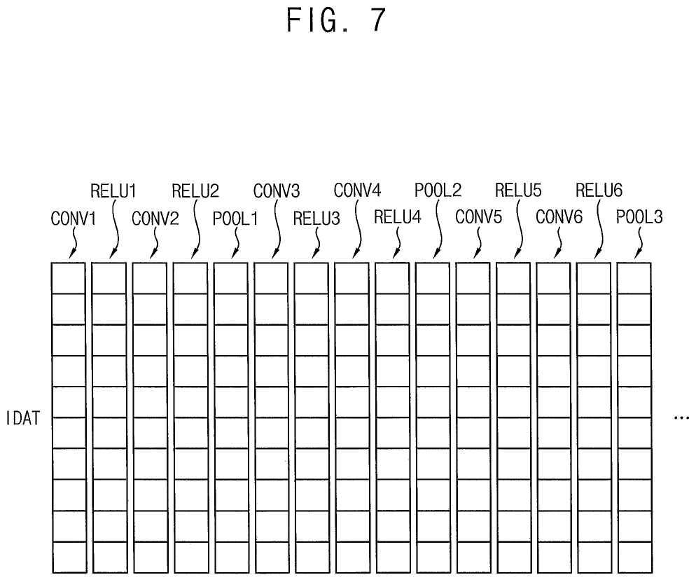

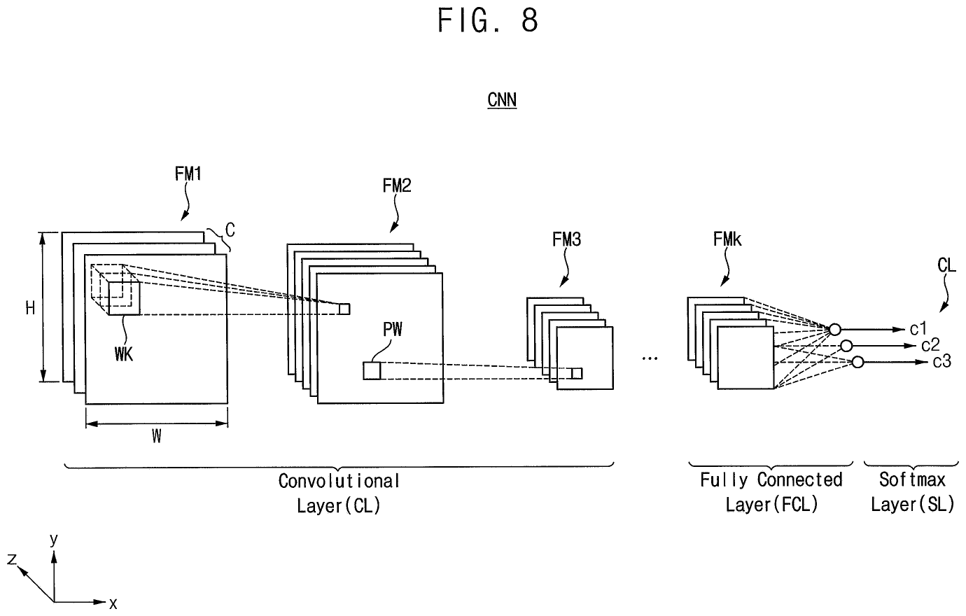

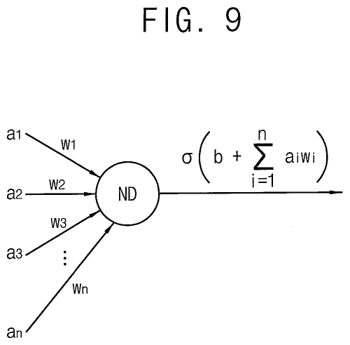

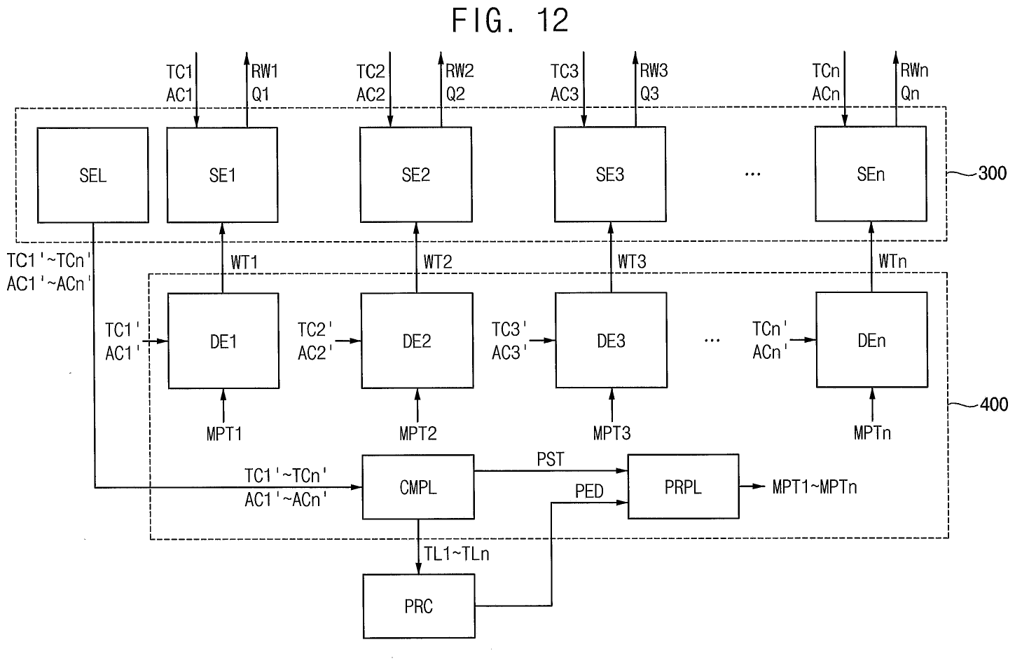

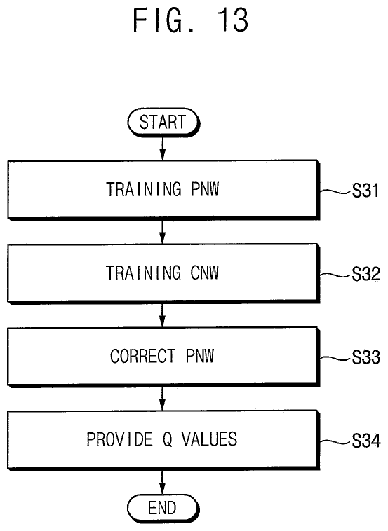

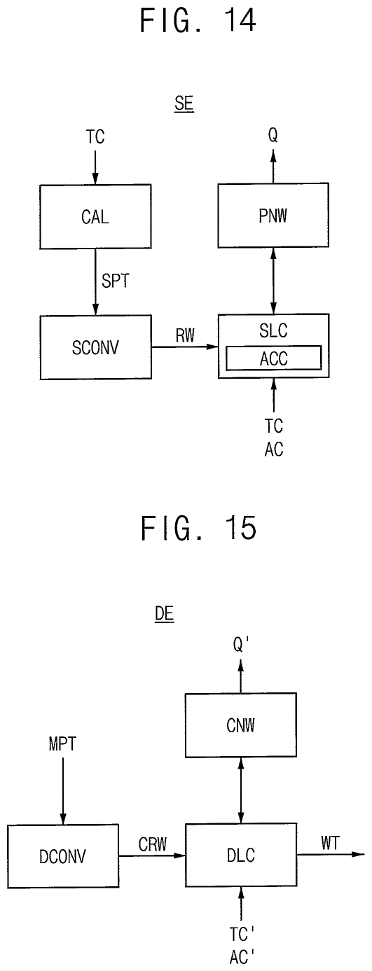

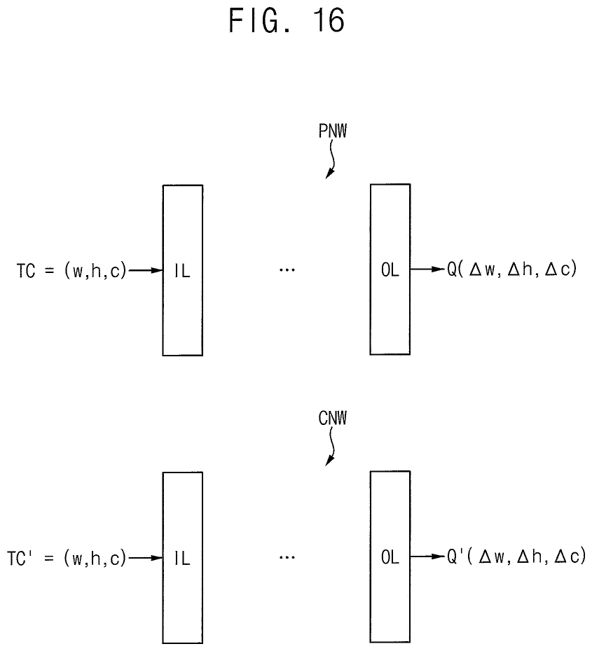

Example embodiments of designing the state, the action and the reward will be described below with reference to FIG. 10, FIG. 11, FIG. 12, FIG. 13, FIG. 14, FIG. 15 and FIG. 16. In advance, a computing system and a neural network to which a system of controlling neural processing according to example embodiments is applied will be described below with reference to FIG. 5, FIG. 6, FIG. 7, FIG. 8 and FIG. 9.

FIG. 5 is a block diagram illustrating a computing system according to example embodiments.

Referring to FIG. 5, a computing system 500 may include a plurality of processors 510, a neural processing control system 10 (NPCS) and a neural network model 540 (NNM). The computing system 500 may further include a special function register 550 (SFR) and a memory 560 (MEM).

The neural processing control system 10 may be driven by the plurality of processors 110. For example, the plurality of processors 510 may include heterogeneous processors as illustrated in FIG. 5. According to example embodiments, the plurality of processors 510 may include at least two homogeneous processors. Various services (e.g., a task TK or an application) such as an image classify service, a user authentication service, an advanced driver assistance system (ADAS) service, and/or a voice assistant service may be executed and processed by the plurality of processors 510.

The task TK may include at least one of a plurality of operations or arithmetic operations. For example, the task TK may represent applications such as an image classification service, a user authentication service based on biological information, an ADAS service, a voice assistant service, etc. For example, the plurality of operations may include various operations such as a convolution operation, a rectified linear unit (RELU) operation, and so on.

The plurality of processors 510 may include a central processing unit (CPU) 511, a graphic processing unit (GPU) 512, a NPU 513 (neural processing unit), a digital signal processor (DSP) 514, an image signal processor (ISP) 515 and a dedicated hardware 516 (DHW). For example, the dedicated hardware 516 may include at least one of a vision processing unit (VPU), a vision intellectual property (VIP), etc. Each processor may be referred to as a processing element (PE).

Although FIG. 5 illustrates only computing resources as examples of the plurality of processors 510, the plurality of processors 510 may further include communication resources such as a direct memory access unit (DMA) for controlling access to the memory 560, a connectivity for supporting various internal and/or external communications, or the like.

As described above, the neural processing control system 10 may include the agent module 100 and the environment module 200. The agent module 100 may generate the plurality of agents based on the plurality of layers included in a neural network model. Each agent may repeatedly perform the iteration to determine the next action among the plurality of candidate actions based on the reward value and the plurality of Q values corresponding to the present action among the plurality of candidate actions, where the plurality of candidate actions indicate the change of the tiling condition of the input feature map of each layer. Each agent may determine the optimal tiling condition of each layer based on change of the reward value according to repeatedly-performed iterations. The environment module 200 may generate the reward value and the plurality of Q values with respect to each layer based on the tiling condition corresponding to the present action, where the plurality of Q values indicate prediction reward values of the plurality of candidate actions.

At least one of the plurality of processors 510 may perform node operations with respect to a plurality of nodes included in each layer of the neural network model 540 to generate a plurality of result values of the node operations. The at least one of the plurality of processors 510 performing the node operations of the neural network model 540 may be referred to as a neural processing device. In general the NPU 513 may perform the node operations but the neural processing device is not limited to the NPU 513.

The optimal tiling conditions OTC, which are determined by the neural processing control system 10, may be stored in the special function register 550 to be used in controlling the neural processing device. In some example embodiments, the optimal tiling conditions OTC may be provided directly to a processor controlling the neural processing device.

According to example embodiments, at least a portion or all of the neural processing control system 10 may be implemented as hardware, may be implemented as software (or program codes) stored in a storage device (such as a non-transitory computer-readable medium), or may be implemented as a combination of hardware and software.

The memory 560 may store various data that are processed by the computing system 500. The memory 560 may include at least one volatile memory such as a dynamic random access memory (DRAM), a synchronous DRAM (SDRAM), a static random access memory (SRAM), etc., and/or at least one nonvolatile memory such as an electrically erasable programmable read-only memory (EEPROM), a flash memory, a phase change random access memory (PRAM), a resistance random access memory (RRAM), a magnetic random access memory (MRAM), a ferroelectric random access memory (FRAM), a nano floating gate memory (NFGM), or a polymer random access memory (PoRAM), etc.

It is understood that all elements in the computing system 500 may be connected to one another via at least one bus, and thus all elements in the computing system 500 may communicate with one another via the at least one bus.

Also, the computing system 500 may further include software elements, e.g., a framework, a kernel or a device driver, a middleware, an application programming interface (API), an application program or an application, or the like. At least a portion of the software elements may be referred to as an operating system (OS).

FIG. 6, FIG. 7 and FIG. 8 are diagrams for describing examples of a neural network structure that is driven by a computing device according to example embodiments.

Referring to FIG. 6, a general neural network may include an input layer IL, a plurality of hidden layers HL1, HL2, . . . , HLn, and an output layer OL.

The input layer IL may include i input nodes x1, x2, . . . , xi, where i is a natural number. Input data (e.g., vector input data) IDAT whose length is i may be input to the input nodes x1, x2, . . . , xi such that each element of the input data IDAT is input to a respective one of the input nodes x1, x2, . . . , xi.

The plurality of hidden layers HL1, HL2, HLn may include n hidden layers, where n is a natural number, and may include a plurality of hidden nodes h¹₁, h¹₂, h¹₃, . . . , h¹ₘ, h²₁, h²₂, h²₃, . . . h²ₘ, hⁿ₁, hⁿ₂, hⁿ₃, . . . , hⁿₘ. For example, the hidden layer HL1 may include m hidden nodes h¹₁, h¹₂, h¹₃, . . . , h¹ₘ, the hidden layer HL2 may include m hidden nodes h²₁, h²₂, h²₃, . . . , h²ₘ, and the hidden layer HLn may include m hidden nodes hⁿ₁, hⁿ₂, hⁿ₃, . . . , hⁿₘ, where m is a natural number.

The output layer OL may include j output nodes y₁, y₂, . . . , yⱼ, where j is a natural number and output the output data DOUT corresponding to the input data IDAT.

A structure of the neural network illustrated in FIG. 6 may be represented by information on branches (or connections) between nodes illustrated as lines, and a weighted value assigned to each branch. Nodes within one layer may not be connected to one another, but nodes of different layers may be fully or partially connected to one another.

Each node (e.g., the node h¹₁) may receive an output of a previous node (e.g., the node x₁), may perform a computing operation, computation, or calculation on the received output, and may output a result of the computing operation, computation, or calculation as an output to a next node (e.g., the node h²₁). Each node may calculate a value to be output by applying the input to a specific function, e.g., a nonlinear function.

The structure of the neural network may be set in advance, and the weighted values for the connections between the nodes are set appropriately using data having an already known answer of which class the data belongs to. The data with the already known answer is referred to as “training data,” and a process of determining the weighted value is referred to as “training.” The neural network “learns” during the training process. A group of an independently trainable structure and the weighted value is referred to as a “model,” and a process of predicting, by the model with the determined weighted value, which class the input data belongs to, and then outputting the predicted value, is referred to as a “testing” process.

The general neural network illustrated in FIG. 6 may not be suitable for handling input image data (or input sound data) because each node (e.g., the node h11) is connected to all nodes of a previous layer (e.g., the nodes x1, x2, . . . , xi included in the layer IL) and then the number of weighted values drastically increases as the size of the input image data increases. Thus, a convolutional neural network (CNN), which is implemented by combining the filtering technique with the general neural network, has been researched such that a two-dimensional image (e.g., the input image data) is efficiently trained by the convolutional neural network.

Referring to FIG. 7, a convolutional neural network may include a plurality of layers CONV1, RELU1, CONV2, RELU2, POOL1, CONV3, RELU3, CONV4, RELU4, POOL2, CONV5, RELU5, CONV6, RELU6, POOLS, and FC.

Unlike the general neural network, each layer of the convolutional neural network may have three dimensions of width, height, and depth. Thus, data that is input to each layer may be volume data having three dimensions of width, height, and depth. For example, if an input image in FIG. 7 has a size of 32 width units (e.g., 32 pixels) and 32 height units (e.g., 32 pixels) and three color channels R, G, and B, then input data IDAT corresponding to the input image may have a size of 32×32×3. The input data IDAT in FIG. 7 may be referred to as input volume data or as an input activation volume.

Each of convolutional layers CONV1, CONV2, CONV3, CONV4, CONV5, and CONV6 may perform a convolutional operation on input volume data. In an image processing, the convolutional operation represents an operation in which image data is processed based on a mask with weighted values, and an output value is obtained by multiplying input values by the weighted values and adding up the total multiplied values. The mask may be referred to as a filter, window, or kernel.

In further detail, parameters of each convolutional layer may consist of or include a set of learnable filters. Every filter may be spatially small (along width and height), but may extend through the full depth of an input volume. For example, during the forward pass, each filter may be slid (more precisely, convolved) across the width and height of the input volume, and dot products may be computed between the entries of the filter and the input at any position. As the filter is slid over the width and height of the input volume, a two-dimensional activation map that gives the responses of that filter at every spatial position may be generated. As a result, an output volume may be generated by stacking these activation maps along the depth dimension. For example, if input volume data having a size of 32×32×3 passes through the convolutional layer CONV1 having four filters with zero-padding, then output volume data of the convolutional layer CONV1 may have a size of 32×32×12 (e.g., a depth of volume data increases).

Each of RELU layers RELU1, RELU2, RELU3, RELU4, RELU5, and RELU6 may perform a rectified linear unit operation that corresponds to an activation function defined by, e.g., a function f(x)=max(0, x) (e.g., an output is zero for all negative input x). For example, if input volume data having a size of 32×32×12 passes through the RELU layer RELU1 to perform the rectified linear unit operation, then output volume data of the RELU layer RELU1 may have a size of 32×32×12 (e.g., a size of volume data is maintained).

Each of pooling layers POOL1, POOL2, and POOLS may perform a down-sampling operation on input volume data along spatial dimensions of width and height. For example, four input values arranged in a 2×2 matrix formation may be converted into one output value based on a 2×2 filter. For example, a maximum value of four input values arranged in a 2×2 matrix formation may be selected based on 2×2 maximum pooling, or an average value of four input values arranged in a 2×2 matrix formation may be obtained based on 2×2 average pooling. For example, if input volume data having a size of 32×32×12 passes through the pooling layer POOL1 having a 2×2 filter, then output volume data of the pooling layer POOL1 may have a size of 16×16×12 (e.g., width and height of volume data decreases, and a depth of volume data is maintained).

Typically, one convolutional layer (e.g., CONV1) and one RELU layer (e.g., RELU1) may form a pair of CONV/RELU layers in the convolutional neural network, pairs of the CONV/RELU layers may be repeatedly arranged in the convolutional neural network, and the pooling layer may be periodically inserted in the convolutional neural network, thereby reducing an image spatial size and extracting an image characteristic.

It is understood that the types and number of layers included in the convolutional neural network may not be limited to the example described above with reference to FIG. 7 and may be changed or vary according to one or more other example embodiments. In addition, it is understood that the convolutional neural network may further include other layers such as a softmax layer for converting score values corresponding to predicted results into probability values, a bias adding layer for adding at least one bias, or the like.

FIG. 8 shows, as an example, the structure of a CNN, as an example of a neural network structure.

The CNN may include a plurality of layers, for example, a convolutional layer CL, a fully-connected layer FCL, a softmax layer SL, and the like. The CNN may have the architecture of a deep neural network DNN or an n-layer neural network. A plurality of layers L1 to Ln may be implemented with the convolutional layer CL, the fully-connected layer FCL, the softmax layer SL, and the like. For example, the convolutional layer CL may include a convolution computation, a pooling computation, an activation function computation, or the like. In addition, the convolution computation, the pooling computation, and the activation function computation may respectively form layers.

A plurality of layers CL, FCL, SL and the like may receive, as an input feature map, a feature map generated in a preceding layer, and compute the input feature map to generate an output feature map or an output signal. In some example embodiments, the CNN is a neural network for classification, and an output of the softmax layer SL may include classes CLS (e.g., first to third classes c1, c2, and c3).

The feature map indicates data in which various features of the input data are expressed. Each of the feature maps FM1, FM2, and FMk may include a two-dimensional matrix or three-dimensional matrix (or a tensor) structure. The feature maps FM1, FM2, and FMk may include at least one channel CH in which feature values are arrayed in rows and columns (matrix). When the feature maps FM1, FM2, FM3, . . . and FMk include a plurality of channels CH, the numbers of rows H and columns W of the plurality of channels CH may be identical to each other. Here, the rows H, the columns W, and the channels CH may respectively correspond to x, y, and z axes on a coordinate system. Feature values assigned to a certain row H and column W in the two-dimensional matrix of x axis and y axis directions may be referred to as an element of the matrix. Hereinafter, a “matrix” described herein indicates a two-dimensional matrix in x axis and y axis directions). For example, the structure of a 4×5 matrix may include 20 elements.

In the convolutional layer CL, a first feature map FM1 may be convoluted with a weight kernel WK to generate a second feature map FM2. In addition, the second feature map FM2 may be pooled down (sampled down or down-sampled) to generate a third feature map FM3. The weight kernel WK may be referred to as a filter or a weight map. The weight kernel WK may filter the first feature map FM1. The weight kernel WK has a similar structure to the feature map. The weight kernel WK includes at least one channel CH in which the weights are arrayed in rows and columns (matrix), and the number of channels CH is the same as that of the channels of a corresponding feature map, for example, the first feature map FM. The same channels CH of the weight kernel WK and the first feature map FM1 may be convoluted.

While the weight kernel WK is shifted on the first feature map FM1 in a sliding window manner, the weight kernel WK may be convoluted with windows (or tiles) of the first feature map FM1. During each shift, each weight included in the weight kernel WK may be multiplied and added with all the feature values in an area superimposed with the first feature map FM1. As the first feature map FM1 is convoluted with the weight kernel WK, one channel of the second feature map FM2 may be generated. One weight kernel WK is shown in FIG. 8, but a plurality of weight kernels WK are substantially convoluted with the first feature map FM1 to generate the second feature map FM2 including a plurality of channels.

The spatial size of the second feature map FM2 may be changed through pooling to generate the third feature map FM3. The pooling may be referred to as sampling or down-sampling. A two-dimensional pooling window PW is shifted by a size unit of a pooling window PW on the second feature map FM2, and top values (or an average value of feature data) may be selected from among the feature data in an area superimposed with the pooling window PW. Accordingly, the third feature map PM3 of which spatial size is changed from the second feature map FM2 may be generated. The third feature map FM2 has the same number of channels as the second feature map FM2.

The fully connected layers FCL may output a computation result indicating how likely that input data is to be classified into each class. In other words, the fully connected layers FCL may output a result value including how likely that the input data is to be classified into a corresponding class using a computation result for each class. In detail, the fully connected layer FCL may include nodes corresponding to respective classes, and each node of the fully connected layers FCL may output a result value for indicating how likely that the input data is to be classified into each class. For example, when the neural network is implemented for a classification work into three classes, each output value of first to third nodes of the fully connected layer FCL may represent the likelihood that the input data is to be classified into a first class c1 to a third class c3.

The fully connected layer FCL may output the computation results to the softmax layer SL, and the softmax layer SL may convert the computation results to probability values. The softmax layer SL may normalize the computation values indicating how likely that the input data is to be classified into each class CLS to generate the probability values. In an exemplary embodiment, the CNN may further include a loss layer, and the softmax layer SL may output the probability values to the loss layer. The loss layer may compute a cross entropy loss that indicates an error in the computation result on the basis of the probability values y.

FIG. 9 is a diagram illustrating an example of a node included in a neural network.

FIG. 9 illustrates an example node operation performed by a node ND in a neural network. When N inputs a1˜an are provided to the node ND, the node ND may multiply the n inputs a1˜an and corresponding n weights w1˜wn, respectively, may sum n values obtained by the multiplication, may add an offset “b” to a summed value, and may generate one output value by applying a value to which the offset “b” is added to a specific function “σ”. The learning operation may be performed based on the training data to update all nodes in the neural network.

FIG. 10 is a diagram for describing a tiling condition in a system of controlling neural processing according to example embodiments.

Referring to FIG. 10, a size of a three-dimensional feature map FM, which is input to a layer of the neural network model NNM may be represented by a width size W, a height size H and a channel size C. The tiling condition TC of the three-dimensional feature map FM may be represented by (w, h, c) including a width division number w, a height division number h and a channel division number c. FIG. 10 illustrates an example that the width size W is divided by three, the height size H is divided by four and the channel size C is divided by two, that is, the tiling condition TC is (3, 4, 2). When the tiling condition TC is (3, 4, 2), the three-dimensional feature map FM may be twenty four (=3*4*2) tiles T111˜T342.

FIG. 11 is a diagram illustrating an example embodiment of candidate actions in a system of controlling neural processing according to example embodiments.

FIG. 11 illustrates a plurality of candidate actions indicating change of the tiling condition TC of the three-dimensional feature map FM of FIG. 10. For example, the plurality of candidate actions may include first through eighth candidate actions CAC1˜CAC8. In FIG. 11, Δw indicates change of the width division number w, Δh indicates change of the height division number h, and Ac indicates change of the channel division number c. In FIG. 11, the value of ‘0’ may indicate decreasing the corresponding division number by a unit value, and the value of ‘1’ may indicate increasing the corresponding division number by the unit value. The unit value may be equal to or different with respect to Δw, Δh and Δc.

For example, the fifth candidate action CAC5 indicates that the width division number w is decreased by the unit value, the height division number h is increased by the unit value and the channel division number c is increased by the unit value, from the present tiling condition TCt. If the unit value is 1 and the present tiling condition TCt is (3, 4, 2) as illustrated in FIG. 10, the next tiling condition TCt+1 becomes (2, 5, 3) when the fifth candidate action CAC5 is determined as the present action.

FIG. 12 is a block diagram illustrating an example embodiment of an environment module included in a system of controlling neural processing according to example embodiments.

Referring to FIG. 12, an environment module may include a simulation environment module 300 and a device environment module 400.

As will be described below with reference to FIG. 14, the simulation environment module 300 may perform simulation to calculate a simulation processing time of the neural network model NNM, and train a prediction network based on the simulation processing time such that the prediction network receives the tiling condition and outputs the plurality of Q values.

As will be described below with reference to FIG. 15, the device environment module 400 may measure a real processing time of a neural processing device driving the neural network model based on the tiling condition corresponding to the present action and train a compensation network based on the real processing time such that the compensation network receives the tiling condition and outputs a plurality of compensation Q values corresponding to the plurality of Q values.

The simulation environment module 300 may include a selector SEL and a plurality of simulation environment units SE1˜SEn. The plurality of simulation environment units SE1˜SEn may respectively correspond to the plurality of agents AG1˜AGn in FIG. 2.

Each simulation environment unit SEi (i=1˜n) of the plurality of simulation environment units SE1˜SEn may receive the tiling condition TCi and the action ACi from each agent AGi and provide the reward value RWi and the plurality of Q values Qi to each agent AGi. The plurality of Q values Qi may respectively correspond to the plurality of candidate actions. For example, when the first through eighth candidate actions CAC1˜CAC8 are set as illustrated in FIG. 11, the eight Q values Qi may be provided from each simulation environment unit SEi to each agent AGi.

As will be described below, each simulation environment unit SEi may include each prediction network corresponding to each agent AGi. Each simulation environment unit SEi may train the prediction network independently of the prediction networks in the other simulation environment units.

The selector SEL may select tiling conditions TC1′˜TCn′ and actions AC1′˜ACn′ of selection iterations corresponding to a portion of a plurality of iterations to be provided to the device environment module 400. The selection iteration may be determined periodically or non-periodically from the plurality of iterations.

The device environment module 400 may include a compiler CMPL, a profiler PRPL and a plurality of device environment units DE1˜Den. The plurality of device environment units DE1˜DEn may respectively correspond to the plurality of agents AG1˜AGn in FIG. 2.

The compiler CMPL may generate a plurality of tile data TLi by dividing the input feature map based on the tiling condition corresponding to the present action and provide the plurality tile data TLi to the neural processing device PRC. In some example embodiments, the neural processing device PRC may be the NPU 513 in FIG. 5, but example embodiments are not limited thereto.

The profiler PRPL may measure the real processing time MPTi required to process the plurality of tile data TLi by the neural processing device PRC. For example, the profiler PRPL may measure the real processing time MPTi based on a processing start signal PST provided from the compiler CMPL and a processing end signal PED provided from the neural processing device PRC, where the processing start signal PST indicates a start time of the neural processing by the neural processing device PRC and the processing end signal PED indicates an end time of the neural processing by the neural processing device PRC.

In some example embodiments, the compiler CMPL and the profiler PRPL may be shared by the plurality of device environment units DE1˜Den. In this case, the compiler CMPL may sequentially provide the plurality of tile data TL1′˜TLn′ respectively corresponding to the plurality of agents AG1˜AGn to the neural processing device PRC, and the profiler PRPL may sequentially measure the plurality of real processing times MPT1˜MPTn respectively corresponding to the plurality of agents AG1˜AGn.

Each device environment unit DEi (i=1˜n) of the plurality of device environment units DE1˜DEn may receive the tiling condition TCi′ and the action ACi′ corresponding to each agent AGi and provided from the selector SEL and receive each real processing time MPTi from the profiler PRPL.

As will be described below, each device environment unit Dei may include each compensation network corresponding to each agent AGi. Each device environment unit DEi may train the compensation network independently of the compensation networks in the other device environment units.

Each device environment unit DEi may provide weight values WTi of the compensation network to each simulation environment unit SEi. Each simulation environment unit SEi may correct weight values of the prediction network based on the received weight values WTi of the compensation network.

As such, the more exact reward may be provided to the agent by correcting the simulation-based reward using the measurement-based reward. Here the reward may include the reward value RW indicating the present reward and the plurality of Q values indicating the future reward. The performance of the neural processing device PRC may be further enhanced by reflecting the parameters such as the operation temperature, the binary size etc. which may affect the real processing time and may be known only when the neural processing device is driven.

FIG. 13 is a flowchart illustrating an example embodiment of generating Q values in a system of controlling neural processing according to example embodiments.

Referring to FIG. 13, each simulation environment unit SEi may train the prediction network PNW included in each simulation environment unit SEi (S31), as will be described below with reference to FIG. 14. In addition, each device environment unit DEi may train the compensation network CNW included in each device environment unit DEi (S32), as will be described below with reference to FIG. 15.

As described with reference to FIG. 12, the weight values of the prediction network PNW may be corrected based on the weight values of the compensation network CNW (S33), and the Q values may be provided based on the corrected prediction network (S34). For example, the weight values of the prediction network PNW may be substituted with the weight values of the compensation network CNW or the weight values of the prediction network PNW may be substituted with average values of the weight values of the prediction network PNW and the weight values of the compensation network CNW, but example embodiments are not limited thereto.

FIG. 14 is a block diagram illustrating an example embodiment of a simulation environment unit included in a system of controlling neural processing according to example embodiments.

Referring to FIG. 14, each simulation environment unit SE may include a calculator CAL, a converter SCONV, a simulation learning controller SLC and a prediction network PNW.

The calculator CAL may calculate the simulation processing time SPT of the neural network model NNM based on the tiling condition TC corresponding to the present action. The converter SCONV may generate the reward value RW based on the simulation processing time SPT. The simulation learning controller SLC may control training of the prediction network PNW based on the reward value RW and the tiling condition TC corresponding to the present action AC.

In some example embodiments, the simulation learning controller SLC may store accumulation information ACC by accumulating actions AC, tiling conditions AC and reward values RW provided during a plurality of iterations and train the prediction network PNW based on the accumulation information ACC. The bias during the training of the prediction network PNW may be prevented or reduced by training the prediction network PNW based on the accumulation information ACC.

FIG. 15 is a block diagram illustrating an example embodiment of a device environment unit included in a system of controlling neural processing according to example embodiments.

Referring to FIG. 14, each device environment unit DE may include a converter DCONV, a device learning controller DLC and a compensation network CNW. In some example embodiments, each device environment unit DE may further include a compiler and a profiler as described with reference to FIG. 12 such that the compiler and the profiler may be dedicated to each device environment unit DE.

The converter DCONV may generate a compensation reward value CRW based on the real processing time MPT provided from the profiler. The device learning controller DLC may control training of the compensation network CNW based on the compensation reward value CRW and the tiling condition TC′ corresponding to the present action AC′.

FIG. 16 is a diagram illustrating a prediction network that is trained by the simulation environment unit of FIG. 14 and a compensation network that is trained by the device environment unit of FIG. 15.

Referring to FIG. 16, the prediction network PNW and the compensation network CNW may include an input layer IL receiving the tiling condition TC or TC′ corresponding to the state of the deep reinforcement learning and an output layer OL generating the Q values Q(Δw, Δh, Δc) or the compensation Q values Q′ (Δw, Δh, Δc) corresponding to candidate actions (Δw, Δh, Δc). For convenience of illustration, the hidden layers between the input layer IL and the output layer OL are omitted in FIG. 16. The structure of the prediction network PNW and the compensation network CNW may be designed variously as described with reference to FIG. 6, FIG. 7, FIG. 8 and FIG. 9.

The prediction network PNW and the compensation network CNW may be implemented to have the same structure. The prediction network PNW may be trained based on the reward value RW corresponding to the simulation processing time SPT. The compensation network CNW may be trained based on the compensation reward value CRW corresponding to the real processing time MPT.

The converter SCONV in FIG. 14 and the converter DCONV in FIG. 15 may use the same function to generate the reward value RW and the compensation reward value CRW based on the simulation processing time SPT and the real processing time MPT, respectively.

The prediction network PNW may receive the tiling condition TC per iteration to generate the Q values Q(Δw, Δh, Δc). In other words, each simulation environment unit SE may train the prediction network PNW once for each iteration.

In contrast, the compensation network CNW may receive the tiling condition TC′ per several iterations to generate the compensation Q values Q(Aw, Ah, Ac). In other words, the device environment unit DE may train the compensation network CNW once for a plurality of iterations.

As described above, each device environment unit DE may transfer the weight values of the compensation network CNW to the simulation environment unit SE and the simulation environment unit SE may correct the weight values of the prediction network PNW based on the weight values of the compensation network CNW.

For example, the weight values of the prediction network PNW may be substituted with the weight values of the compensation network CNW. Alternatively, the weight values of the prediction network PNW may be substituted with average values of the weight values of the prediction network PNW and the weight values of the compensation network CNW, but example embodiments are not limited thereto.

The deep reinforcement learning based on simulation may be performed rapidly but the characteristics of the real device may not be reflected. In contrast, the deep reinforcement learning based on the real measurement may reflect the characteristics of the real device but the learning time is increased.

The system and the method according to example embodiments may provide the more exact reward to the agent by correcting the simulation-based reward using the measurement-based reward. The performance of the neural processing device may be further enhanced by reflecting the parameters such as the operation temperature, the binary size etc. which may be known only when the neural processing device is driven.

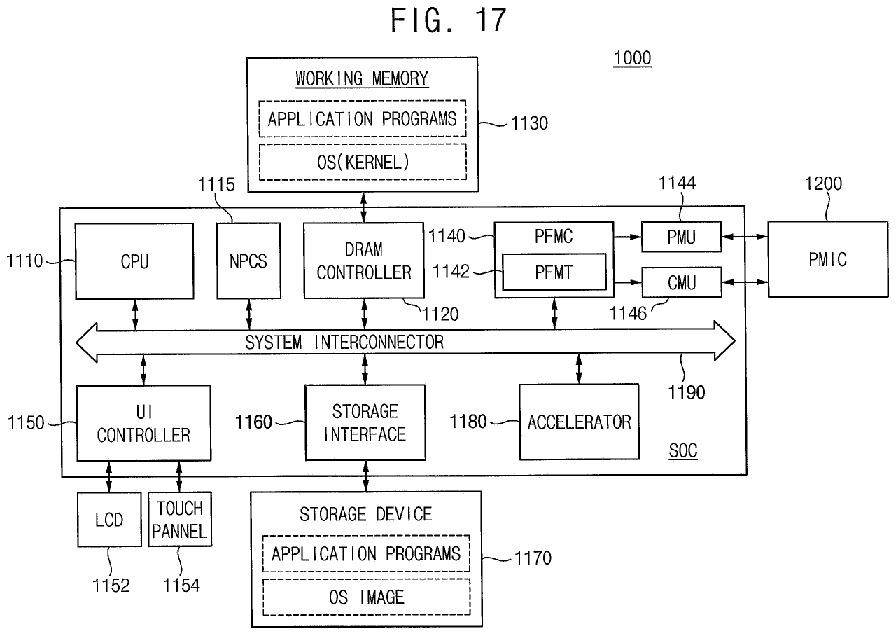

FIG. 17 is a block diagram illustrating a computing system according to example embodiments.

Referring to FIG. 17, a computing system 1000 may include a system on chip (SoC), a working memory 1130, a LCD 1152 (display device), a touch panel 1154, a storage device 1170, a PMIC 1200 (power management integrated circuit), etc. The SoC may include a processor 1110 (e.g., a CPU), a neural processing control system 1115 (NPCS), a DRAM controller 1120, a performance controller 1140, a user interface controller 1150 (UI controller), a storage interface 1160, and an accelerator 1180, a PMU 1144 (power management unit), a CMU 1146 (clock management unit), etc. It will be understood that components of the computing system 1000 are not limited to the components shown in FIG. 17. For example, the computing system 1000 may further include a hardware codec for processing image data, a security block, and the like.

The processor 1110 executes software (for example, an application program, an operating system (OS), and device drivers) for computing system 1000. The processor 1110 may execute the operating system (OS) which may be loaded into the working memory 1130. The processor 1110 may execute various application programs to be driven on the operating system (OS). The processor 1110 may be provided as a homogeneous multi-core processor or a heterogeneous multi-core processor. A multi-core processor is a computing component including at least two independently drivable processors (hereinafter referred to as “cores” or “processor cores”). Each of the cores may independently read and execute program instructions.

According to example embodiments, the neural processing control system 1115 may include the agent module and the environment module as described above. The agent module may generate the plurality of agents based on the plurality of layers included in a neural network model. Each agent may repeatedly perform the iteration to determine the next action among the plurality of candidate actions based on the reward value and the plurality of Q values corresponding to the present action among the plurality of candidate actions, where the plurality of candidate actions indicate the change of the tiling condition of the input feature map of each layer. Each agent may determine the optimal tiling condition of each layer based on change of the reward value according to repeatedly-performed iterations. The environment module may generate the reward value and the plurality of Q values with respect to each layer based on the tiling condition corresponding to the present action, where the plurality of Q values indicate prediction reward values of the plurality of candidate actions.

The processor cores of the processor 1100 may be grouped into a plurality of clusters that operate with an independent driving clock and an independent driving voltage. The processor cores in the same cluster may be included in a clock domain operating based on the same clock signal and/or in a power domain operating based on the same driving voltage. The driving voltage and/or the clock signal provided to each of the processor cores may be cut off or connected in units of single cores.

A kernel of the operating system (OS) may monitor the number of tasks in a task queue and the driving voltage and the driving clock of the processor 1110 at specific time intervals to control the processor 1110. In addition, a kernel of the operating system (OS) may control hotplug-in or hotplug-out of the processor 1110 with reference to the monitored information.

The DRAM controller 1120 provides interfacing between the working memory 1130 and the system-on-chip (SoC). The DRAM controller 1120 may access the working memory 1130 according to a request of the processor 1110 or another intellectual property (IP) block.

The operating system (OS) or basic application programs may be loaded into the working memory 1130 during a booting operation. For example, an OS image stored in the storage device 1170 is loaded into the working memory 1130 based on a booting sequence during booting of the computing system 1000. Overall input/output operations of the computing system 1000 may be supported by the operating system (OS). The working memory 1130 may be a volatile memory such as a static random access memory (SRAM) and a dynamic random access memory (DRAM) or a nonvolatile memory device such as a phase-change random-access memory (PRAM), a magnetoresistive random-access memory (MRAM), a resistive random-access memory (ReRAM), a ferroelectric random-access memory (FRAM), and a NOR flash memory.

The performance controller 1140 may adjust operation parameters of the system-on-chip (SoC) according to a control request provided from the kernel of the operating system (OS). For example, the performance controller 1140 may adjust the level of dynamic voltage and frequency scaling (DVFS) to enhance performance of the system-on-chip (SoC). Alternatively, the performance controller 1140 may control the frequencies of the processor cores according to a request of the kernel. In this case, the performance controller 1140 may include a performance table 1142 to set a driving voltage and a frequency of a driving clock therein. The performance controller 1140 may control the PMU 1144 and the CMU 1146, which together form a power managing circuit, connected to the PMIC 1200 to provide the determined driving voltage and the determined driving clock to each power domain.

The user interface controller 1150 controls user input and output from user interface devices. For example, the user interface controller 1150 may display a keyboard screen for inputting data to the LCD 1152 according to the control of the processor 1110. Alternatively, the user interface controller 1150 may control the LCD 1152 to display data that a user requests. The user interface controller 1150 may decode data provided from user input means, such as a touch panel 1154, into user input data.

The storage interface 1160 accesses the storage device 1170 according to a request of the processor 1110. For example, the storage interface 1160 provides interfacing between the system-on-chip (SoC) and the storage device 1170. For example, data processed by the processor 1110 is stored in the storage device 1170 through the storage interface 1160. Alternatively, data stored in the storage device 1170 may be provided to the processor 1110 through the storage interface 1160.

The storage device 1170 is provided as a storage medium of the computing system 1000. The storage device 1170 may store application programs, an OS image, and various types of data. The storage device 170 may be provided as a memory card (e.g., MMC, eMMC, SD, MicroSD, etc.). The storage device 170 may include a NAND-type flash memory with a high-capacity storage capability. Alternatively, the storage device 1170 may include a next-generation nonvolatile memory such as PRAM, MRAM, ReRAM, and FRAM or a NOR-type flash memory.

The accelerator 1180 may be provided as a separate intellectual property (IP) component to increase processing speed of a multimedia or multimedia data. The term “intellectual property component” may refer to a unique circuit or other component that is independently protected or protectable by intellectual property. For example, the accelerator 1180 may be provided as an intellectual property (IP) component to enhance processing performance of a text, audio, still images, animation, video, two-dimensional data or three-dimensional data.

A system interconnector 1190 may be a system bus to provide an on-chip network in the system-on-chip (SoC). The system interconnector 1190 may include, for example, a data bus, an address bus, and a control bus. The data bus is a data transfer path. A memory access path to the working memory 1130 or the storage device 1170 may also be provided. The address bus provides an address exchange path between intellectual properties (IPs). The control bus provides a path along which a control signal is transmitted between intellectual properties (IPs). However, the configuration of the system interconnector 1190 is not limited to the above description and the system interconnector 190 may further include arbitration means for efficient management.

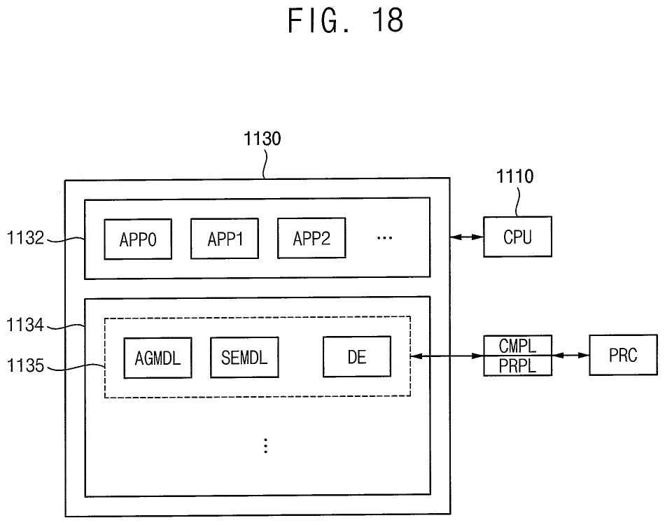

FIG. 18 is a diagram illustrating an example embodiment of a system of controlling neural processing implemented in the computing system of FIG. 17.

FIG. 18 illustrates an example software structure of the computing system 1000 shown in FIG. 17. Referring to FIG. 18, a software layer structure of the computing system 1000 loaded into the working memory 1130 and driven by the processor 1110 may be divided into an application program 1132 and a kernel 1134. The operating system (OS) may further include one or more device drivers to manage various devices such as a memory, a modem, and an image processing device.

The application program 1132 may be upper layer software driven as a basic service or driven by a user's request. A plurality of application programs APP0, APP1 and APP2 may be simultaneously executed to provide various services. The application programs APP0, APP1 and APP2 may be executed by the processor 1110 after being loaded into the working memory 1130.

The kernel 1134, as a component of the operating system (OS), performs a control operation between the application program 1132 and hardware. The kernel 1134 may include program execution, interrupt, multi-tasking, memory management, a file system, and a device driver.

According to example embodiments, an agent module AGMDL, a simulation environment module SEMDL and a plurality of instances of the device environment unit DE may be provided as a portion of the kernel 1134. In contrast, a compiler CMPL and a profiler PRPL for providing the real processing time by the neural processing device PRC as described above may be provided as hardware.

As described above, the system and the method according to example embodiments may efficiently enhance the performance of the neural processing device by determining the optimal tiling condition through automatic training of the neural network model regardless of the kind of the neural network model and the hardware and software characteristics of the neural processing device. In addition, the system and the method according to example embodiments may provide the more exact reward to the agent by correcting the simulation-based reward using the measurement-based reward. The performance of the neural processing device may be further enhanced by reflecting the parameters such as the operation temperature, the binary size etc. which may be known only when the neural processing device is driven.

As will be appreciated by one skilled in the art, embodiments of the inventive concept(s) described herein may be embodied as a system, method, computer program product, or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain, or store a program for use by or in connection with an instruction execution system, apparatus, or device.

The example embodiments may be applied to devices and systems performing neural processing. For example, the example embodiments may be applied to systems such as a mobile phone, a smart phone, a personal digital assistant (PDA), a portable multimedia player (PMP), a digital camera, a camcorder, a personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, a server system, an automotive driving system, etc.

The foregoing is illustrative of example embodiments and is not to be construed as limiting thereof. Although a few example embodiments have been described, those skilled in the art will readily appreciate that many modifications are possible in the example embodiments without materially departing from the inventive concept(s) described herein.

What is claimed is:

1. A system of controlling neural processing based on deep reinforcement learning, comprising:
an agent circuit configured to generate a plurality of agents based on a plurality of layers included in a neural network model, each agent repeatedly performing an iteration to determine a next action among a plurality of candidate actions based on a reward value and a plurality of Q values corresponding to a present action among the plurality of candidate actions, each agent determining an optimal tiling condition of each layer based on change of the reward value according to repeatedly-performed iterations, the plurality of candidate actions indicating a change of a tiling condition of an input feature map of each layer; and
an environment circuit configured to generate the reward value and the plurality of Q values with respect to each layer based on a tiling condition corresponding to the present action, the plurality of Q values indicating prediction reward values of the plurality of candidate actions.

2. The system of claim 1, wherein the agent circuit varies a number of the plurality of agents depending on a number of the plurality of layers included in the neural network model.

3. The system of claim 1, wherein each agent repeat the iteration to determine the optimal tiling condition of each layer regardless of other agents.

4. The system of claim 1, wherein the agent circuit groups agents corresponding to layers of a same kind, a same size of the input feature map and a same size of output feature map into each agent group.

5. The system of claim 4, wherein the agents in each agent group share the reward value and the plurality of Q values.

6. The system of claim 5, wherein, when one agent in each agent group determines the optimal tiling condition first, the other agents in each agent group stop operations.

7. The system of claim 6, wherein the agent circuit determines the optimal tiling condition determined by the one agent as optimal tiling conditions of layers corresponding to the other agents.

8. The system of claim 5, wherein the agent circuit enables one agent in each agent group and disables the other agents in each agent group.

9. The system of claim 8, wherein the agent circuit determines the optimal tiling condition determined by the one agent as optimal tiling conditions of layers corresponding to the other agents.

10. The system of claim 1, wherein the environment circuit includes:
a simulation environment circuit configured to perform simulation to calculate a simulation processing time of the neural network model, and train a prediction network based on the simulation processing time such that the prediction network receives the tiling condition and outputs the plurality of Q values.

11. The system of claim 10, wherein the simulation environment circuit stores accumulation information by accumulating actions, tiling conditions and reward values provided during a plurality of iterations and trains the prediction network based on the accumulation information.

12. The system of claim 10, wherein the simulation environment circuit trains a plurality of prediction networks corresponding to the plurality of agents.

13. The system of claim 10, wherein the simulation environment circuit includes:
a calculator configured to calculate the simulation processing time of the neural network model based on the tiling condition corresponding to the present action;
a converter configured to generate the reward value based on the simulation processing time; and
a simulation learning controller configured to control training of the prediction network based on the reward value and the tiling condition corresponding to the present action.

14. The system of claim 10, wherein the environment circuit further includes:
a device environment circuit configured to measure a real processing time of a neural processing device driving the neural network model based on the tiling condition corresponding to the present action and train a compensation network based on the real processing time such that the compensation network receives the tiling condition and outputs a plurality of compensation Q values corresponding to the plurality of Q values.

15. The system of claim 14, wherein the device environment circuit trains a plurality of compensation networks corresponding to the plurality of agents.

16. The system of claim 14, wherein the device environment circuit includes:
a compiler configured to generate a plurality of tile data by diving the input feature map based on the tiling condition corresponding to the present action and provide the plurality tile data to the neural processing device;
a profiler configured to measure the real processing time required to process the plurality of tile data by the neural processing device;
a converter configured to generate a compensation reward value based on the real processing time; and
a device learning controller configured to control training of the compensation network based on the compensation reward value and the tiling condition corresponding to the present action.

17. The system of claim 14, wherein the device environment circuit transfers weight values of the compensation network to the simulation environment circuit and the simulation environment circuit corrects weight values of the prediction network based on the weight values of the compensation network.

18. The system of claim 14, wherein the simulation environment circuit trains the prediction network once for each iteration, and the device environment circuit trains the compensation network once for a plurality of iterations.

19. A system of controlling neural processing based on deep reinforcement learning, comprising:
an agent circuit configured to generate a plurality of agents based on a plurality of layers included in a neural network model, each agent repeatedly performing an iteration to determine a next action among a plurality of candidate actions based on a reward value and a plurality of Q values corresponding to a present action among the plurality of candidate actions, each agent determining an optimal tiling condition of each layer based on change of the reward value according to repeatedly performed iterations, the plurality of candidate actions indicating a change of a tiling condition of an input feature map of each layer;
a simulation environment circuit configured to perform simulation to calculate a simulation processing time of the neural network model, and train a prediction network based on the simulation processing time such that the prediction network receives the tiling condition and outputs the plurality of Q values; and
a device environment circuit configured to measure a real processing time of a neural processing device driving the neural network model based on the tiling condition corresponding to the present action and train a compensation network based on the real processing time such that the compensation network receives the tiling condition and outputs a plurality of compensation Q values corresponding to the plurality of Q values,
wherein a structure of the prediction network is identical to a structure of the compensation network, and the simulation environment circuit corrects weight values of the prediction network based on weight values of the compensation network.

20. A method of controlling neural processing based on deep reinforcement learning, comprising:
generating a plurality of agents based on a plurality of layers included in a neural network model;
repeatedly performing, by each agent, an iteration to determine a next action among a plurality of candidate actions based on a reward value and a plurality of Q values corresponding to a present action among the plurality of candidate actions, the plurality of candidate actions indicating a change of a tiling condition of an input feature map of each layer;
generating the reward value and the plurality of Q values with respect to each layer based on a tiling condition corresponding to the present action, the plurality of Q values indicating prediction reward values of the plurality of candidate actions; and
determining, by each agent, an optimal tiling condition of each layer based on change of the reward value according to repeatedly performed iterations.
